(19) United States
(12) Patent Application Publication
(10) Pub. No.: US 2013/0293923 A1
(43) Pub. Date: Nov. 7, 2013

(54) PREDICTION OF PRINT QUALITY DEVIATIONS IN A PRINTING SYSTEM

(71) Applicants: Ward I. Fisher, Lafayette, CO (US); Michael J. Holley, Broomfield, CO (US); Yann LeCostaouec, Westminster, CO (US); Nenad Rijavec, Longmont, CO (US); Sathya Vadlamani, Erie, CO (US); Jason C. Walp, Louisville, CO (US); Cheyenne C. Wills, Jamestown, CO (US)

(72) Inventors: Ward I. Fisher, Lafayette, CO (US); Michael J. Holley, Broomfield, CO (US); Yann LeCostaouec, Westminster, CO (US); Nenad Rijavec, Longmont, CO (US); Sathya Vadlamani, Erie, CO (US); Jason C. Walp, Louisville, CO (US); Cheyenne C. Wills, Jamestown, CO (US)

(21) Appl. No.: 13/462,916

(22) Filed: May 3, 2012

(51) Int. Cl. G06F 3/12; G06K 15/02

(52) U.S. Cl. 358/1.15

(57) ABSTRACT

Methods and systems herein provide for estimating when the print quality of a printer is expected to decrease below a threshold based on a function of change in the print quality of the printer. In one embodiment, a system calculates a plurality of print quality measurements based on pages printed by a printer. The system determines a function of change of the print quality of the printer that is based on changes in the print quality measurements. The system estimates when the print quality of the printer is expected to decrease below a threshold based on the function of change in the print quality of the printer. The system then provides the estimate to a print operator.

### FIELD OF THE INVENTION

The invention relates to the field of printing systems, and in particular, to the print quality of a printing system.

### BACKGROUND

Production printing systems typically include some form of a print quality system that verifies that the pages printed by the printing system meet or exceed various criteria for ensuring a quality printed product. The print quality system may include one or more imaging devices that captures image data of a printed page output from the printing system, and compares the image data to reference data for the page, such as the print data utilized for printing the page. The print quality system may consider a number of print criteria for the page for determining the print quality of the printer, such as registration, contrast, ink density, divergence, legibility of text, etc. Generally, the printing process continues as long as the print quality is within some form of metric, such as a threshold value for the print criteria. When a measured value for the print criteria deviates beyond a threshold, the print operator may then be alerted and react to problems that exist in the print quality of the printing system. However, a reactionary approach to deviations in the print quality of the printing system is not a particularly efficient way of handling problems in a production printing environment. It thus remains a problem to efficiently deal with problems of print quality deviations in a printing system that extends beyond this reactionary approach.

### SUMMARY

Embodiments described herein provide for estimating when the print quality of a printer is expected to decrease below a threshold based on a function of change in the print quality of pages printed by the printer. Print quality measurements are calculated based on pages printed by the printer. A function of change of the print quality of the printer is determined based on the print quality measurements, and an estimate is made as to when the print quality of the printer is expected to decrease below a threshold based on the function of change of the print quality. The estimate is provided to a print operator, which may allow the print operator to make decisions about how to plan for future activities in anticipation of the print quality deviations.

In an embodiment, a system is disclosed. The system calculates print quality measurements based on pages printed by a printer. The system determines a function of change of the print quality of the printer based on changes in the print quality measurements. The system estimates when the print quality of the printer is expected to decrease below a threshold based on the function of change in the print quality of the printer. The system then provides the estimate to a print operator.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of a printing system in an exemplary embodiment.

FIG. 2 is flow chart illustrating a method of estimating when the print quality of a printer is expected to decrease below a threshold in an exemplary embodiment.

FIG. 3 is a block diagram of another printing system in an exemplary embodiment.

FIG. 4 illustrates a computing system in which a computer readable medium may provide instructions for performing the method of FIG. 2 in an exemplary embodiment.

### DESCRIPTION OF THE EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

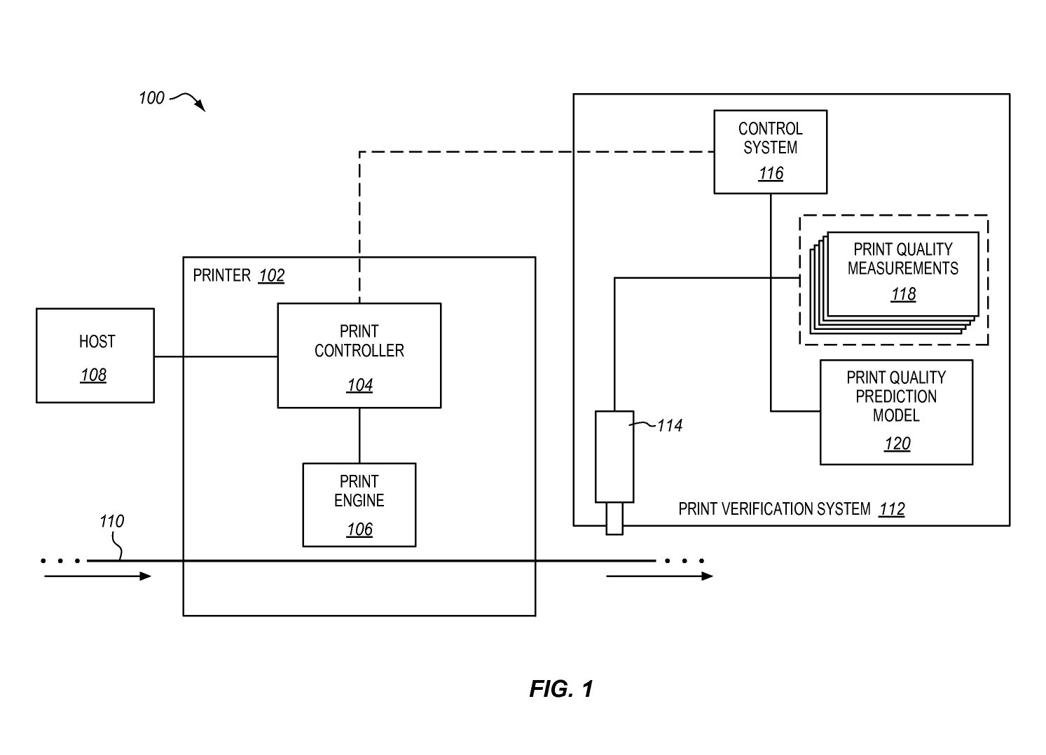

FIG. 1 is a block diagram of a printing system 100 in an exemplary embodiment. Printing system 100 includes a printer 102 and a print verification system 112. Generally, printer 102 marks a printable medium 110, such as paper. Print verification system 112 monitors the print quality of printer 102 by analyzing the markings made on media 110 by printer 102. In this embodiment, printer 102 includes a print controller 104 and a print engine 106. Print controller 104 receives print jobs from host 108 for imprinting onto media 110. Media 110 may include continuous form media or cut sheet media as a matter of design choice. Print jobs typically include “raw” print data in a page description language (PDL) such as Printer Control Language (PCL), PostScript data, etc. Print jobs may also include a job ticket that specifies various characteristics of the print job, such as a type of media to use when printing the job (e.g., size, weight, color, etc.), the number of logical pages per sheet side, which media trays at the printer to pull media from when printing the job, etc. Print jobs received by print controller 104 are rasterized into bitmap data and provided to print engine 106. Print engine 106 then marks media 110 based on the bitmap data. In response to printer 102 marking media 110, print verification system 112 may capture digital image(s) (e.g., via camera 114) of one or more pages of output printed by printer 102, and then compare the digital images to the print data for the page(s) to determine the differences. The differences represent deviations between a printed output of printer 102 as defined by the print data and an actual printed output of printer 102. Thus, the differences are representative of the print quality of printer 102.

In prior systems, the differences are used to determine if the printed page(s) violate one or more print quality criteria. For example, the differences may indicate problems related to registration, ink density, color saturation, legibility of a barcode, gray balance, color consistency across pages, dot gain, and line width variation, etc., with the printed pages. If print quality criteria are violated in prior systems, a print operator is alerted that the print quality of the printed output is not as expected or as desired. This static analysis may be problematic for a number of reasons. First, the print operator is not alerted to a print quality issue for the printer until the print quality violates the metric used to flag the operator. In this case, the print operator may not have been aware that an issue with the print quality of the printer may have been subtly growing as a problem over time until the criteria is violated. The second reason that the static analysis approach in prior systems is problematic is that the print operator is left with reacting to print quality violations instead of anticipating and planning for print quality violations. Reacting to a problem is generally a less efficient approach to take in solving the problem, as it leaves less flexibility in planning for downtime, assembling resources to solve the problem prior to beginning the work, etc.

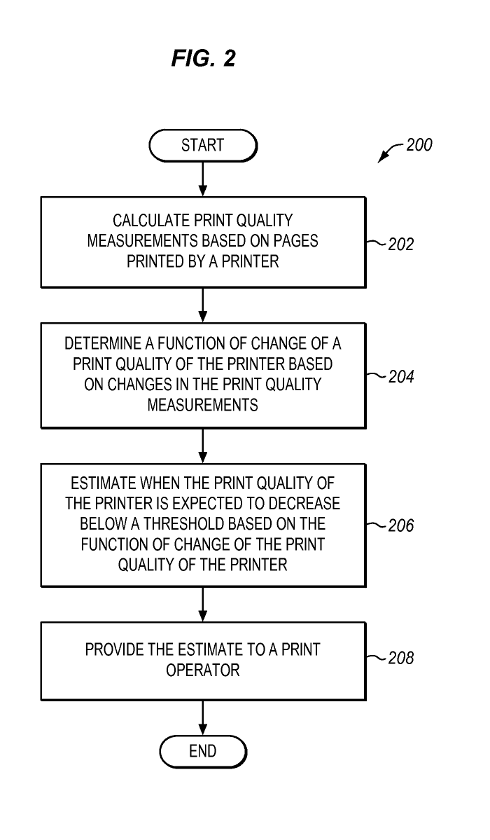

In this embodiment, print verification system 112 provides estimates to a print operator as to when a print quality issue from printer 102 is expected to occur. For example, print verification system 112 may indicate to a print operator that a problem with the ink density in the printed pages is estimated to deviate beyond an allowable value in about 5,000 pages, or at a particular time in the future, such as at 3 pm (e.g., the time may be based on an average print speed of printer 102). The estimate allows the print operator to plan for possible print quality deviations that may occur at some point in the future. To provide the estimates to the print operator, print verification system 112 analyzes print quality measurements 118 taken from pages printed by printer 102, and determines a variation in the print quality of printer 102 based on print quality measurements 118. Print quality measurements 118 are not simply a single static snapshot of the print quality of printer 102, but instead are a number of print quality measurements recorded, captured, and/or derived over time, over a number of pages, etc. Using the historical information about how the print quality of printer 102 has been in the past, print verification system 112 may predict how the print quality of printer 102 may change in the future. Print verification system 112 may then generate a print quality prediction model 120 that represents a mathematical model of various print quality criteria based on print quality measurements 118. Model 120 may then allow print verification system 112 to estimate or predict how the print quality for printer 102 may change in the future. The estimate allows a print operator advanced notice of future print quality deviations that may then be used for planning corrective action to resolve such future print quality problems. This renders the printing process of printing system 100 more efficient. How print verification system 112 may operate will be discussed in more detail with regard to FIG. 2.

FIG. 2 is flow chart illustrating a method 200 of estimating when the print quality of printer 102 is expected to decrease below a threshold in an exemplary embodiment. The steps of method 200 will be described with respect to print verification system 112 of FIG. 1, although one skilled in the art will understand that method 200 may be performed by other systems not shown. The steps of the methods described herein are not all inclusive and may include other steps not shown. The steps may also be performed in an alternative order.

Assume for this embodiment that host 108 generates a print job for printer 102, and transmits the print job to printer 102 for imprinting to media 110. In this embodiment, the print quality of printer 102 varies over time, over a number of pages printed, etc. This may occur because the printing process approximates the print data in the job utilizing colorant nozzles, imaging drums, etc., which are limited by the physical processes used to approximate the print data.

In step 202, control system 116 of print verification system 112 (see FIG. 1) calculates a plurality of print quality measurements 118 based on pages printed by printer 102. The print quality measurements may be performed with any imaging device, such as color cameras, monochrome cameras, line scanners, spectrophotometers, densitometers, etc. Print quality measurements 118 may represent one or more print quality criteria as determined by print verification system 112 when analyzing media 110 during the printing process. Print quality measurements 118 may represent any number of criteria as a matter of design choice. For example, print quality measurements 118 may track a sheetside mark on the edge of media 110, and determine how the sheetside mark varies with respect to an edge of media 110 during the printing process. This determination may indicate how accurate print engine 106 is registered with the edge of media 110, which may affect the accuracy in centering printed images within media 110.

In step 204, control system 116 determines a variation of print quality of printer 102 based on changes in print quality measurements 118. In this embodiment, print quality measurements 118 are snapshots of the print quality of printer 102 at particular points in time, and/or at particular pages in a series of printed pages. For example, print verification system 112 may analyze a series of pages printed by printer 102 (e.g., every thousand pages), and determine how the print quality of printer 102 deviates from the print data for the corresponding pages. The deviations of the print quality of printer 102 may change subtly over time, over a number of pages, etc., which is captured by control system 116.

In step 206, control system 116 estimates when the print quality of printer 102 is expected to decrease below a threshold based on the variations in the print quality of printer 102. The variation in the print quality may also be referred to as a function of change of the print quality, as a temporal variation in the print quality, etc. The threshold may represent a metric used by the print operator in measuring an acceptable lower limit for the print quality of printer 102. Using the variation in print quality determined in step 204, control system 116 may estimate that the print quality of printer 102 is expected to transition from an acceptable print quality to an unacceptable print quality at some future time or page count based on the threshold used to define the print quality of a particular criterion.

In step 208, control system 116 provides the estimate calculated in step 206 to the print operator. Using the estimate, the print operator may plan or anticipate a future print quality violation or deviation from the desired or acceptable printed output from printer 102. This may allow the print operator to plan ahead in performing maintenance on printer 102 to correct the print quality issues that are estimated to occur at some future point in time or page position in a print job. The print operator may, for example, recognize that the estimate suggests that the print quality issue is expected to occur after print job #1 is printed, but before print job #2 finishes printing. Using the estimate, the print operator may suspend print job #2 from printing until maintenance is performed on printer 102. This allows the print operator to be less reactionary in handling print quality issues that arise with printer 102, and more proactive in handling print quality issues that may arise with printer 102. Often, being proactive is a more efficient way of dealing with print quality issues that may arise in a production printing system, such as system 100.

In some embodiments, control system 116 may take action automatically based on the estimate calculated in step 206. For example, if the estimate indicates that a color is expected to drift out of tolerance at some future point in time, then control system 116 may suspend color jobs from printing and instead print monochrome jobs.

In other embodiments, control system 116 utilizes the variations in print quality measurements 118 calculated in step 204 to construct print quality prediction model 120. Print quality prediction model 120 is a mathematical representation of the print quality of printer 102 as a function of time, a number of pages to print, etc. Model 120 may be used to predict how print quality measurements 118 may change in the future. Control system 116 may input page count information, time information, etc., into model 120 and receive an estimate of a future value for one or more print quality criteria. Control system 116 may also compare the predicted value(s) received from model 120 to the actual values measured by print quality print verification system 112. This may allow control system 116 to update model 120 to be more accurate in representing how print quality measurements 118 change in the future. In addition, model 120 may be used to correlate variables in the print quality of printer 102 that the print operator may be unaware of For example, the print operator may be unaware of how the print quality of printer 102 changes over time based on a temperature of the room housing printer 102, a humidity of the room housing printer 102, a time of day that printer 102 is printing, work shifts (e.g., shifts 1, 2, 3, etc., that may correlate to a particular employee operating printer 102). More particularly, the print operator may not actually capture some of these variables as print quality measurements 118; instead, the correlations may be determined by analyzing the predictive nature of model 120 as a function of one or more unrecognized factors determined in the future, such as temperature, humidity, a particular print operator, etc. As such, model 120 may provide insight into correlations and relationships between diverse sets of factors that the print operator may not recognize as being related to the print quality of printer 102.

### EXAMPLE

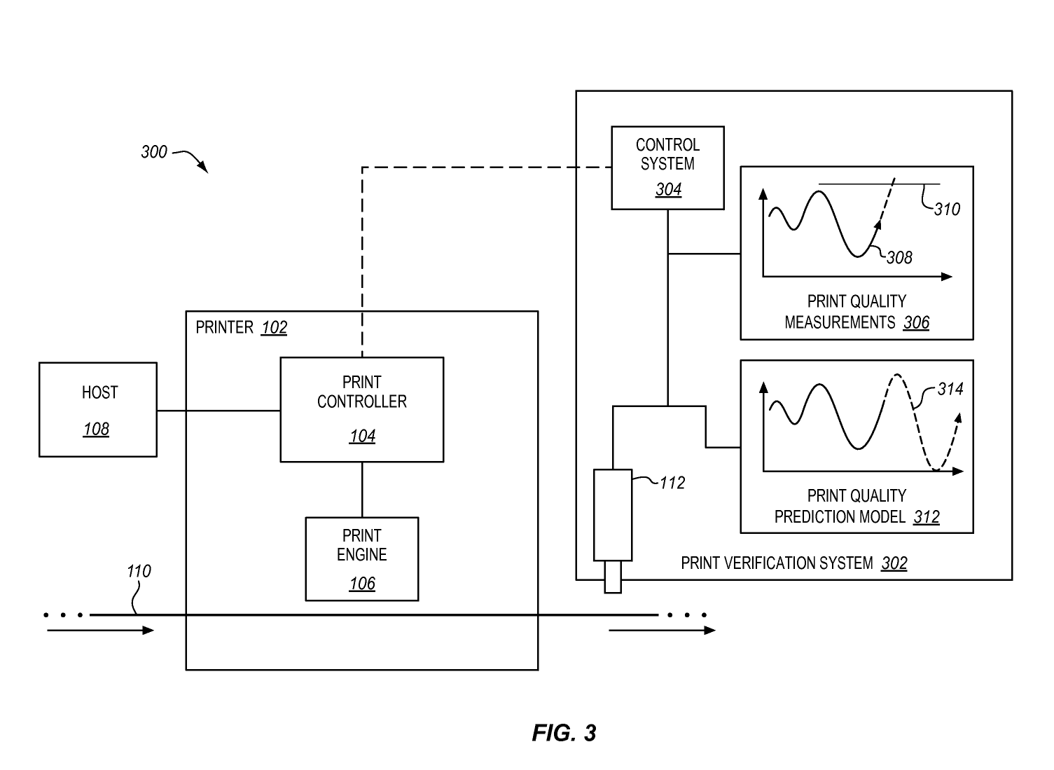

FIG. 3 is a block diagram of another printing system 300 in an exemplary embodiment that includes print verification system 302. In the example, control system 304 of print verification system 302 receives image data (e.g., from camera 112), and calculates print quality measurements 306. Print quality measurements 306 in the example represent a temporal variation in a sheetside registration mark 308 imprinted onto media 110 relative to an edge of media 110. Registration mark 308 is not static in the example, but instead varies based on a lateral movement of media 110 relative to print engine 106. While it is common for some lateral movement, or wobble, of media 110 relative to print engine 106, print quality measurements 306 illustrate that the wobble of media 110 (as determined by registration mark 308 relative to an edge of media 110) is increasing over time. That is, the values recorded for registration mark 308 deviate more (as shown relative to the vertical arrow in print quality measurements 306) over time (as shown relative to the horizontal arrow illustrated in print quality measurements 306). Based on the variation of print quality measurements 306 determined by control system 304, control system 304 estimates when the print quality of printer 102 is expected to decrease below and/or beyond an acceptable print quality threshold 310. In the example, the estimate is illustrated by the dashed line extending beyond threshold 310, where threshold 310 represents a lateral wobble limit between an edge of media 110 and print engine 106. Control system 304 then provides the estimate to the print operator, who may then make the appropriate plans to correct the possible print quality issue that is developing in printer 102. For example, the estimate may indicate to the print operator that the wobble for media 110 is expected to cross beyond a limit in about 5,000 pages. The estimate may also indicate a time that the limit is reached based on the printing speed of printer 102 and the number of pages in the estimate.

Control system 304 may also create a print quality prediction model 312, which illustrates a mathematical representation 314 of how registration mark 308 may deviate over time (or a number of pages printed by printer 102) based on the historical information recorded for registration mark 308. Control system 304 may then compare the representation 314 with information received at a future point in time for registration mark 308, thus allowing control system 304 to more accurately fit representation 314 to real world data.

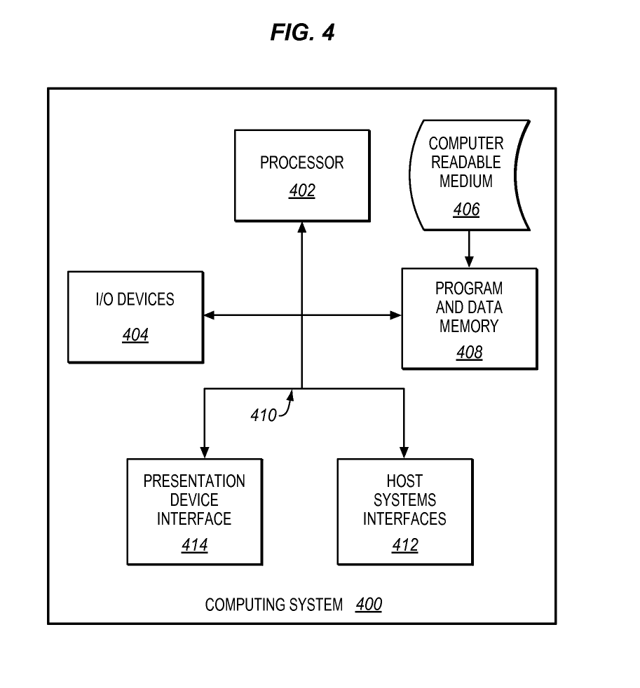

The invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 4 illustrates a computing system 400 in which a computer readable medium may provide instructions for performing the method of FIG. 2 in an exemplary embodiment.

Furthermore, the invention can take the form of a computer program product accessible from a computer-usable or computer-readable medium 406 providing program code for use by or in connection with a computer or any instruction execution system. For the purposes of this description, a computer-usable or computer readable medium 406 can be any apparatus that can tangibly store the program for use by or in connection with the instruction execution system, apparatus, or device.

The medium 406 can be any tangible electronic, magnetic, optical, electromagnetic, infrared, or semiconductor system (or apparatus or device). Examples of a computer-readable medium 406 include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include one or more processors 402 coupled directly or indirectly to memory 408 through a system bus 410. The memory 408 can include local memory employed during actual execution of the program code, bulk storage, and cache memories which provide temporary storage of at least some program code in order to reduce the number of times code is retrieved from bulk storage during execution.

Input/output or I/O devices 404 (including but not limited to keyboards, displays, pointing devices, etc.) can be coupled to the system either directly or through intervening I/O controllers.

Network adapters may also be coupled to the system to enable the data processing system to become coupled to other data processing systems, such a through host systems interfaces 412, or remote printers or storage devices through intervening private or public networks. Modems, cable modem and Ethernet cards are just a few of the currently available types of network adapters.

Although specific embodiments were described herein, the scope of the invention is not limited to those specific embodiments. The scope of the invention is defined by the following claims and any equivalents thereof.

We claim:

1. A system comprising:
a control system operable to calculate print quality measurements based on pages printed by a printer, and to determine a function of change of a print quality of the printer based on changes in the print quality measurements; and
the control system further operable to estimate when the print quality of the printer is expected to decrease below a threshold based on the function of change in the print quality of the printer, and to provide the estimate to a print operator.

2. The system of claim 1 wherein:
the control system is further operable to estimate a number of pages that may be printed before the print quality of the printer is expected to decrease below the threshold, and to provide the estimated number of pages to the print operator.

3. The system of claim 2 wherein:
the control system is further operable to compare the estimated number of pages to pages remaining in a print job that is printing, and to determine if the print job may print to completion without the print quality of the printer decreasing below the threshold.

4. The system of claim 3 wherein:
the control system is further operable to indicate to the print operator that the print job may continue printing based on determining that the print job may print to completion without the print quality of the printer decreasing below the threshold.

5. The system of claim 1 wherein:
the control system is further operable to estimate a time before the print quality of the printer is expected to decrease below the threshold, and to provide the estimated time to the print operator.

6. The system of claim 1 wherein:
the control system is further operable to construct a mathematical model based on the changes in one or more of the print quality measurements, and to generate the estimate based on the model.

7. The system of claim 6 wherein:
the control system is further operable to compare the estimate to a new set of print quality measurements, to determine if the estimate approximates the new set of print quality measurements, and to adjust the model in response to determining that the estimate does not approximate the new set of print quality measurements.

8. A method comprising:
calculating print quality measurements based on pages printed by a printer;
determining a function of change of a print quality of the printer based on changes in the print quality measurements;
estimating when the print quality of the printer is expected to decrease below a threshold based on the function of change in the print quality of the printer; and
providing the estimate to a print operator.

9. The method of claim 8 wherein:
estimating further comprises:
estimating a number of pages that may be printed before the print quality of the printer is expected to decrease below the threshold; and
providing the estimate further comprises:
providing the estimated number of pages to the print operator.

10. The method of claim 9 further comprising:
comparing the estimated number of pages to pages remaining in a print job that is printing; and
determining if the print job may print to completion without the print quality of the printer decreasing below the threshold.

11. The method of claim 8 further comprising:
estimating a time before the print quality of the printer is expected to decrease below the threshold; and
providing the estimated time to the print operator.

12. The method of claim 8 further comprising:
constructing a mathematical model based on the changes in one or more of the print quality measurements; and
generating the estimate based on the model.

13. The method of claim 12 further comprising:
comparing the estimate to a new set of print quality measurements;
determining if the estimate approximates the new set of print quality measurements; and
adjusting the model in response to determining that the estimate does not approximate the new set of print quality measurements.

14. A non-transitory computer readable medium comprising programmed instructions which, when executed by a processor, are operable to perform a method of estimating when the print quality of a printer is expected to decrease below a threshold, the method comprising:
calculating print quality measurements based on pages printed by a printer;
determining a function of change of a print quality of the printer based on changes in the print quality measurements;
estimating when the print quality of the printer is expected to decrease below a threshold based on the function of change in the print quality of the printer; and
providing the estimate to a print operator.

15. The non-transitory medium of claim 14 wherein:
the method step of estimating further comprises:
estimating a number of pages that may be printed before the print quality of the printer is expected to decrease below the threshold; and
the method step of providing the estimate further comprises:
providing the estimated number of pages to the print operator.

16. The non-transitory medium of claim 15, wherein the method further comprises:
comparing the estimated number of pages to pages remaining in a print job that is printing; and
determining if the print job may print to completion without the print quality of the printer decreasing below the threshold.

17. The non-transitory medium of claim 16, wherein the method further comprises:
indicating to the print operator that the print job may continue printing based on determining that the print job may print to completion without the print quality of the printer decreasing below the threshold.

18. The non-transitory medium of claim 14, wherein the method further comprises:
estimating a time before the print quality of the printer is expected to decrease below the threshold; and
providing the estimated time to the print operator.

19. The non-transitory medium of claim 14, wherein the method further comprises:
constructing a mathematical model based on the changes in one or more of the print quality measurements; and
generating the estimate based on the model.

20. The non-transitory medium of claim 19, wherein the method further comprises:
comparing the estimate to a new set of print quality measurements;
determining if the estimate approximates the new set of print quality measurements; and
adjusting the model in response to determining that the estimate does not approximate the new set of print quality measurements.
